(19) United States
(12) Patent Application Publication
(10) Pub. No.: US 2025/0293459 A1
(43) Pub. Date: Sep. 18, 2025

(54) CONNECTOR

(71) Applicant: SUMITOMO WIRING SYSTEMS, LTD., Mie (JP)

(72) Inventors: Yuki HIROSE, Mie (JP); Takanobu YAMAGAMI, Mie (JP)

(21) Appl. No.: 19/072,586

(22) Filed: Mar. 6, 2025

(30) Foreign Application Priority Data
Mar. 14, 2024 (JP) 2024-040004

(51) Int. Cl. H01R 13/627

(52) U.S. Cl. CPC H01R 13/6271

(57) ABSTRACT

A connector 10 includes a terminal 20, a housing 30 for holding the terminal 20, a slider 60 to be accommodated inside the housing 30 and movable to a first position and a second position along a first axis X, and a spring 70 for biasing the slider 60. The spring 70 includes a pair of arms 71 extending along a second axis Y intersecting the first axis X and a coupling portion 75 coupling the pair of arms 71 and configured to contact the slider 60. The coupling portion 75 extends along a third axis Z intersecting both the first axis X and the second axis Y. The spring 70 biases the slider 60 toward the first position with the coupling portion 75 held in contact with the slider 60 along the third axis Z.

### CROSS-REFERENCE TO RELATED APPLICATIONS

This application is based on and claims priority from Japanese Patent Application No. 2024-040004, filed on Mar. 14, 2024, with the Japan Patent Office, the disclosure of which is incorporated herein in its entirety by reference.

### TECHNICAL FIELD

The present disclosure relates to a connector.

### BACKGROUND

Conventionally, a connector used to control an airbag inflator or the like, i.e. a so-called squib connector, is installed in a vehicle (see, for example, Japanese Patent Laid-open Publication No. 2016-021397). The connector of this type is provided with a terminal, a housing for holding the terminal, a slider accommodated inside the housing and a spring for biasing the slider. The spring includes a pair of operation arms for pressing the slider and torsion coil portions provided on end parts of the pair of operation arms. In the above connector, the connection of the connector and a mating connector is guaranteed by sliding the slider by a biasing force of the spring. Specifically, the slider is moved rearward by receiving a reaction force of the spring when the connector and the mating connector are connected. After the connection of the connector and the mating connector is completed, the slider is moved forward by the reaction force of the spring. Specifically, the slider is moved forward by being pressed by the pair of operation arms.

### SUMMARY

In the above connector, it is desired to further improve connection reliability to the mating connector.

The present disclosure aims to provide a connector capable of improving connection reliability to a mating connector.

The present disclosure is directed to a connector with a terminal, a housing for holding the terminal, a slider to be accommodated inside the housing, the slider being movable to a first position and a second position along a first axis, and a spring for biasing the slider, the spring including a pair of arms extending along a second axis intersecting the first axis and a coupling portion coupling the pair of arms, the coupling portion contacting the slider, the coupling portion extending along a third axis intersecting both the first axis and the second axis, and the spring biasing the slider toward the first position with the coupling portion held in contact with the slider along the third axis.

According to the connector of the present disclosure, an effect of being able to improve connection reliability to a mating connector is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to one embodiment and a mating connector.

FIG. 2 is an exploded perspective view showing the connector of the embodiment.

FIG. 3 is a plan view showing a part of the connector of the embodiment.

FIG. 4 is a section (along 4-4 in FIG. 3) showing the connector of the embodiment.

FIG. 5 is a perspective view showing a slider of the embodiment.

FIG. 6 is a section (along 6-6 in FIG. 3) showing the connector of the embodiment.

FIG. 7 is a section showing the connector of the embodiment.

FIG. 8 is a section showing the connector of the embodiment.

FIG. 9 is a section (along 9-9 in FIG. 3) showing the connector of the embodiment and the mating connector.

FIG. 10 is a section showing the connector of the embodiment and the mating connector.

FIG. 11 is a section showing the connector of the embodiment and the mating connector.

FIG. 12 is a section showing the connector of the embodiment and the mating connector.

FIG. 13 is a perspective view in section showing a part of the connector of the embodiment.

FIG. 14 is a perspective view in section showing a part of the connector of the embodiment.

FIG. 15 is a perspective view showing a spring of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

[1] The connector of the present disclosure is provided with a terminal, a housing for holding the terminal, a slider to be accommodated inside the housing, the slider being movable to a first position and a second position along a first axis, and a spring for biasing the slider, the spring including a pair of arms extending along a second axis intersecting the first axis and a coupling portion coupling the pair of arms, the coupling portion contacting the slider, the coupling portion extending along a third axis intersecting both the first axis and the second axis, and the spring biasing the slider toward the first position with the coupling portion held in contact with the slider along the third axis.

According to this configuration, the slider is biased toward the first position by the spring with the coupling portion coupling the pair of arms held in line contact with the slider along the third axis. In this way, a contact region of the spring and the slider, particularly a contact region along the third axis, can be increased as compared to the case where only the pair of arms contact the slider. Thus, when the slider is moved from the second position to the first position along the first axis by a biasing force of the spring, the biasing force can be applied to the slider in a well-balanced manner and the slider can be moved in a well-balanced manner. Therefore, when the slider moves from the second position to the first position, the inclination of the slider with respect to the third axis can be suitably suppressed and the slider can be moved in a stable posture. As a result, a reaction force of the spring can be suitably applied to the slider, wherefore connection to a mating connector can be suitably guaranteed, utilizing the spring and the slider. Such a connection guarantee suitably functions, whereby a connection failure such as an incompletely connected state of the connector and the mating connector can be suitably suppressed. As a result, the connection reliability of the connector and the mating connector can be improved.

[2] In [1] described above, each of the pair of arms may include a first end part connected to the coupling portion and a second end part provided on a side opposite to the first end part, and the spring may further include folded portions folded from the second end parts toward the first end parts.

According to this configuration, the spring can be so structured that the second end part of each arm does not have a torsion coil shape. In this way, the spring can be reduced in size as compared to the conventional structure having the torsion coil shape.

[3] In [2] described above, the spring may further include extending portions extending along the third axis from the folded portions, and the extending portion may be capable of contacting an inner surface of the housing.

According to this configuration, a contact area of the spring and the inner surface of the housing can be increased by as much as the extending portions. By the contact of the spring and the inner surface of the housing, a movement of the spring inside the housing can be suitably restricted. Thus, the spring can be suitably maintained in a desired posture inside the housing.

[4] In any one of [1] to [3] described above, each of the pair of arms may include a rising portion rising in a first oblique direction from the coupling portion and a falling portion falling in a second oblique direction intersecting the first oblique direction from an end part of the rising portion, and the rising portion may be inclined in a direction away from the slider with distance from the coupling portion.

According to this configuration, each arm of the spring is formed to be bent into an inverted V shape. In this way, a biasing force can be suitably applied to the slider by each arm.

[5] In any one of [1] to [4] described above, the slider may include a connection guaranteeing portion for guaranteeing connection to the mating connector, the connection guaranteeing portion may be a part to be pressed by a mating-side connection guaranteeing portion of the mating connector, and the coupling portion may be provided at a position overlapping the connection guaranteeing portion in a plan view viewed along the first axis.

According to this configuration, when the connector and the mating connector are connected, the connection guaranteeing portion of the slider is pressed by the mating-side connection guaranteeing portion. The coupling portion of the spring is provided to overlap this connection guaranteeing portion in the plan view. Thus, when the connection guaranteeing portion is pressed by the mating-side connection guaranteeing portion, the coupling portion is brought into line contact with the slider along the third axis at that position overlapping the connection guaranteeing portion. Therefore, when the connection guaranteeing portion is pressed by the mating-side connection guaranteeing portion, the slider can be suitably supported by the coupling portion of the spring. As a result, when the slider is moved from the first position to the second position as being pressed by the mating-side connection guaranteeing portion, the inclination of the slider with respect to the third axis can be suitably suppressed and the slider can be moved in the stable posture.

[6] In any one of [1] to [5] described above, the housing may include a guide groove extending along the first axis, the slider may include a guide protrusion to be fit into the guide groove, the guide protrusion extending along the first axis, the guide protrusion may be formed to be engageable with the guide groove along the second axis, and the slider may be movable along the first axis with the guide protrusion fit in the guide groove.

According to this configuration, the slider is moved along the first axis with the guide protrusion fit in the guide groove. At this time, the guide protrusion is engaged with the guide groove along the second axis. Thus, when the slider moves along the first axis, the inclination of the slider with respect to the second axis can be suitably suppressed and the slider can be moved in the stable posture.

[7] In any one of [1] to [6] described above, the slider may include a spring accommodating portion for accommodating the arms and the coupling portion, the spring accommodating portion may include a bottom surface and a wall portion projecting from the bottom surface, and the wall portion may include a guiding portion for guiding the spring into an internal space of the spring accommodating portion.

According to this configuration, when the spring is mounted into the housing, the spring can be smoothly inserted into the internal space of the spring accommodating portion by being moved along the guiding portion. In this way, the assembly workability of the connector can be improved.

[8] In any one of [1] to [7] described above, the housing may include a housing body having a terminal accommodating portion for accommodating the terminal and a cover member to be attached to the housing body, and the housing may be formed into a tube surrounding an outer periphery of the slider and an outer periphery of the terminal by uniting the housing body and the cover member.

According to this configuration, the housing is formed into the tube surrounding the outer periphery of the slider and the outer periphery of the terminal by a plurality of components, i.e. the housing body and the cover member. In this way, the housing can be attached to the terminal and the like later since the housing is divided into the plurality of components although having the tubular shape. Therefore, the assembly workability of the terminal and the like with the housing can be improved and the assembly workability of the connector can be improved.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure. “Orthogonal” and “parallel” in this specification mean not only strictly orthogonal and parallel, but also substantially orthogonal and parallel within a range in which functions and effects in this embodiment are achieved. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape or a U shape. Note that “tubular” shapes include circular shapes, elliptical shapes and polygonal shapes with angular or round corners, but there is no limitation to these. “Facing each other” in this specification indicates that surfaces or members are at positions in front of each other, and means not only a case where the surfaces or members are at positions perfectly in front of each other, but also a case where the surfaces or members are partially in front of each other. “Facing each other” in this specification means not only a case where two members are separated from each other, but also a case where the two members are in contact with each other. Further, terms such as “first”, “second” and “third” in this specification are merely used to distinguish objects and do not rank the objects. Note that the present invention is not limited to these illustrations, but is represented by claims and intended to include all changes in the scope of claims and in the meaning and scope of equivalents.

### (Overall Configuration of Connector 10)

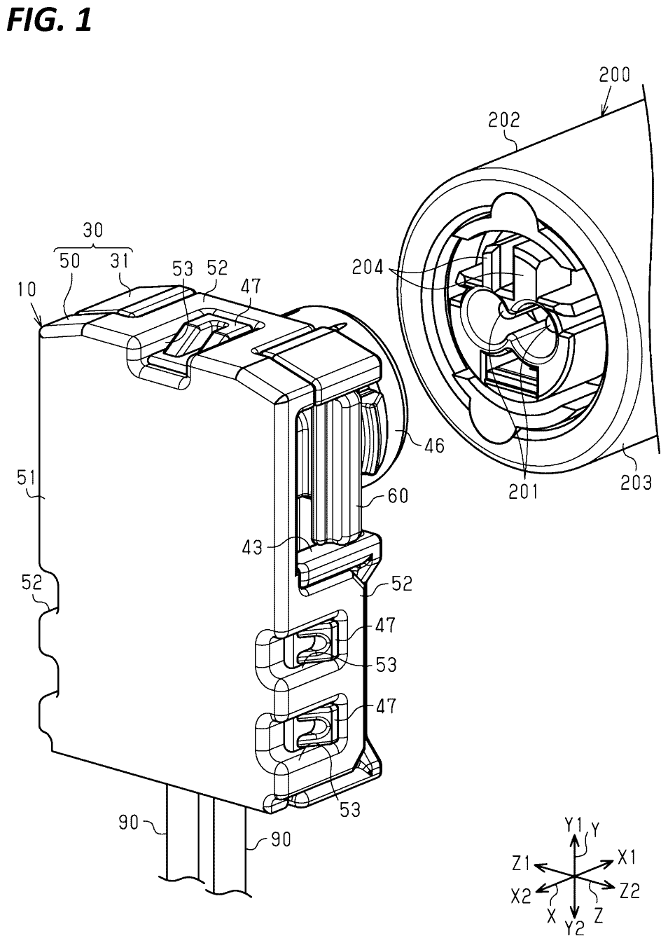

As shown in FIG. 1, a connector 10 is configured to be connectable to a mating connector 200. The connector 10 is, for example, provided in an unillustrated vehicle such as a hybrid vehicle or an electric vehicle. Further, the connector 10 is a connector used to control a seat belt pretensioner, an airbag inflator or the like of the vehicle, i.e. a so-called squib connector.

A first axis X, a second axis Y orthogonal to the first axis X and a third axis Z orthogonal to both the first and second axes X, Y are shown in each figure. Further, a forward direction X1, which is one direction along the first axis X, and a rearward direction X2, which is another direction along the first axis X and a direction opposite to the forward direction X1, are shown in each figure. Here, the forward direction X1 is a forward direction along a connection direction of the connector 10 to the mating connector 200. An upward direction Y1, which is one direction along the second axis Y, and a downward direction Y2, which is another direction along the second axis Y and a direction opposite to the upward direction Y1, are shown in each figure. A first width direction Z1, which is one direction along the third axis Z, and a second width direction Z2, which is another direction along the third axis Z and a direction opposite to the first width direction Z1, are shown in each figure. Note that each direction in each figure does not necessarily indicate postures of the connector 10 and the mating connector 200 during use. Further, the description of directions in the mating connector 200 is based on a state where the mating connector 200 is connected to the connector 10.

### (Configuration of Mating Connector 200)

The mating connector 200 includes mating terminals 201 and a mating housing 202 for holding the mating terminals 201. The mating housing 202 includes a mating-side fitting tube portion 203 to be fit to a housing 30 of the connector 10 and a mating-side connection guaranteeing portion 204 for guaranteeing the connection of the connector 10 and the mating connector 200. The mating terminals 201 are provided inside the mating-side fitting tube portion 203. The mating-side connection guaranteeing portion 204 is provided inside the mating-side fitting tube portion 203.

### (Configuration of Connector 10)

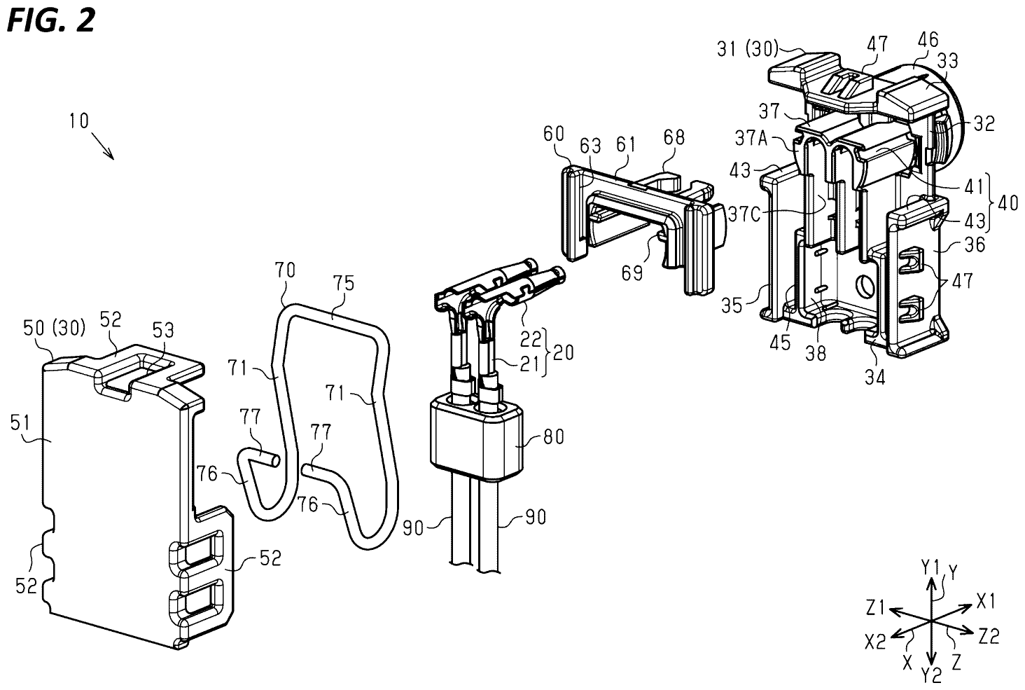

As shown in FIG. 2, the connector 10 is provided with terminals 20, the housing 30, a slider 60, a spring 70 and a ferrite core 80. The connector 10 of this embodiment is provided with two terminals 20.

### (Configuration of Terminals 20)

The two terminals 20 are provided side by side along the third axis Z. Each terminal 20 includes a wire connecting portion 21 and a female terminal portion 22. The wire connecting portion 21 extends along the second axis Y. The female terminal portion 22 extends along the first axis X. Each terminal 20 is L-shaped as a whole. Each terminal 20 is made of metal.

The wire connecting portion 21 is connected to a wire 90. Here, the wire 90 is a coated wire including an electrically conductive core wire and an insulation coating covering the outer periphery of the core wire. The wire connecting portion 21 is connected to an end part of the core wire of the wire 90. The wire connecting portion 21 is, for example, connected to the core wire of the wire 90 by crimping, ultrasonic welding or the like.

The female terminal portion 22 is connected to an end part in the upward direction Y1 of the wire connecting portion 21. The female terminal portion 22 extends in a direction orthogonal to a length direction of the wire connecting portion 21. The female terminal portion 22 has a tubular shape.

### (Configuration of Housing 30)

The housing 30 includes a housing body 31 and a cover member 50 formed to be attachable to the housing body 31. The housing body 31 is in the form of a box open in the rearward direction X2. The cover member 50 is attached to the housing body 31 to close an opening of the housing body 31. The housing body 31 and the cover member 50 are separate members. Each of the housing body 31 and the cover member 50 is made of resin.

The housing 30 is formed into a tube surrounding the terminals 20, the slider 60 and the spring 70 by uniting the housing body 31 and the cover member 50. In other words, the terminals 20, the slider 60 and the spring 70 are accommodated in an internal space of the housing 30 formed by the housing body 31 and the cover member 50.

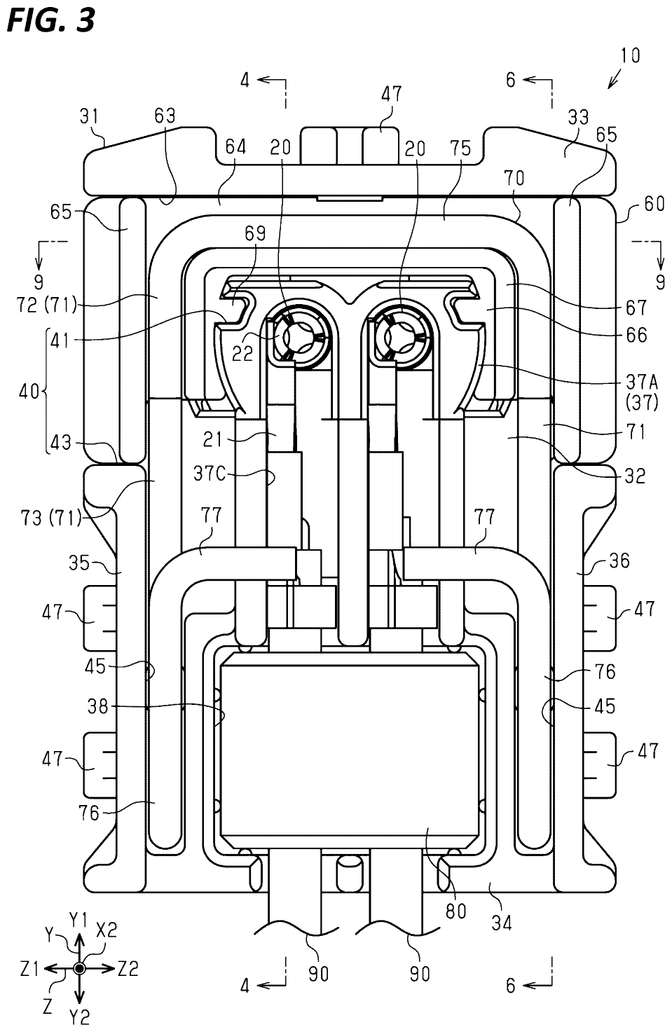

As shown in FIGS. 2 and 3, the housing body 31 includes a base portion 32 and peripheral walls 33, 34, 35 and 36 projecting in the rearward direction X2 from the base portion 32. The housing body 31 includes a terminal accommodating portion 37 for accommodating the terminals 20 and a ferrite accommodating portion 38 for accommodating the ferrite core 80. The housing body 31 includes a mounting portion 40, into which the slider 60 is mounted, and spring accommodating portions 45 for accommodating the spring 70. As shown in FIG. 3, the housing body 31 of this embodiment includes two spring accommodating portions 45. Note that the cover member 50 is not shown in FIG. 3 to simplify FIG. 3.

As shown in FIG. 2, the base portion 32 is in the form of a flat plate. The peripheral wall 33 is provided in an end part in the upward direction Y1 of the base portion 32. The peripheral wall 34 is provided in an end part in the downward direction Y2 of the base portion 32. The peripheral walls 33, 34 extend along the third axis Z. The peripheral wall 35 is provided in an end part in the first width direction Z1 of the base portion 32. The peripheral wall 36 is provided in an end part in the second width direction Z2 of the base portion 32. The peripheral walls 35, 36 extend along the second axis Y.

The terminal 20 is inserted along the forward direction X1 into the terminal accommodating portion 37. The terminal accommodating portion 37 is so formed that the two terminals 20 arranged along the third axis Z can be held.

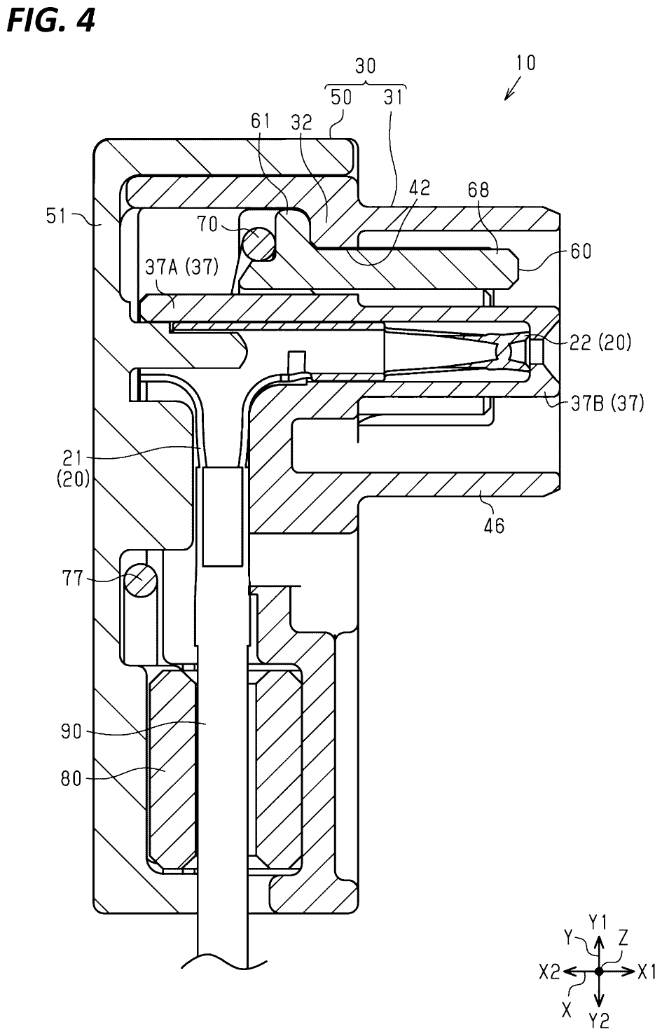

As shown in FIG. 4, the terminal accommodating portion 37 includes a tubular portion 37A projecting in the rearward direction X2 from the base portion 32 and a tubular portion 37B projecting in the forward direction X1 from the base portion 32. An internal space of the tubular portion 37A and that of the tubular portion 37B communicate with each other. The female terminal portions 22 of the terminals 20 are accommodated into the tubular portions 37A, 37B.

As shown in FIG. 3, the terminal accommodating portion 37 includes accommodation grooves 37C for accommodating the wire connecting portions 21 of the terminals 20. The accommodation groove 37C extends along the downward direction Y2 from the tubular portion 37A. An internal space of the accommodation groove 37C communicates with that of the tubular portion 37A.

As shown in FIG. 2, the ferrite core 80 mounted on the outer peripheries of the wires 90 is inserted along the forward direction X1 into the ferrite accommodating portion 38. The ferrite accommodating portion 38 extends along the downward direction Y2 from the accommodation grooves 37C of the terminal accommodating portion 37. An internal space of the ferrite accommodating portion 38 communicates with those of the accommodation grooves 37C.

The slider 60 is mounted along the forward direction X1 into the mounting portion 40. The mounting portion 40 holds the slider 60 movably along the first axis X in an internal space of the housing 30. The mounting portion 40 includes guide grooves 41 provided in the outer peripheral surface of the tubular portion 37A, a through hole 42 (see FIG. 4) penetrating through the base portion 32 and cut portions 43 provided in the peripheral walls 35, 36.

Guide protrusions 69 of the slider 60 are inserted along the forward direction X1 into the guide grooves 41. The guide groove 41 extends along the first axis X. The guide groove 41 extends over the entire length in an axial direction of the tubular portion 37A.

As shown in FIG. 4, the through hole 42 is provided on a side further in the upward direction Y1 than the tubular portion 37A. A connection guaranteeing portion 68 of the slider 60 is inserted along the forward direction X1 through the through hole 42.

As shown in FIG. 2, the cut portion 43 is provided in each of the peripheral walls 35, 36. The cut portions 43 are formed by cutting end parts in the upward direction Y1 of the peripheral walls 35, 36.

The two spring accommodating portions 45 are respectively provided in both end parts along the third axis Z. An arm 71 of the spring 70 is inserted along the forward direction X1 into each spring accommodating portion 45. As shown in FIG. 3, the spring accommodating portion 45 is in the form of a groove extending along the second axis Y. The spring accommodating portion 45 provided in an end part in the first width direction Z1 is formed by being surrounded by the outer peripheral surface of the ferrite accommodating portion 38 and the peripheral walls 34, 35. The spring accommodating portion 47 provided in an end part in the second width direction Z1 is formed by being surrounded by the outer peripheral surface of the ferrite accommodating portion 38 and the peripheral walls 34, 36.

As shown in FIG. 1, the housing body 31 includes a fitting tube portion 46 to be fit to the mating-side fitting tube portion 203 of the mating housing 202. The fitting tube portion 46 is fit into the mating-side fitting tube portion 203. As shown in FIG. 2, the fitting tube portion 46 projects in the forward direction X1 from the base portion 32.

As shown in FIG. 3, the housing body 31 includes engaging portions 47 provided on the peripheral walls 33, 35 and 36. The engaging portion 47 is an engaging projection projecting outward from the outer surface of the peripheral wall 33, 35, 36. The peripheral wall 33 is provided with one engaging portion 47. Each of the peripheral walls 35, 36 is provided with two engaging portions 47.

### (Configuration of Cover Member 50)

As shown in FIG. 1, the cover member 50 is attached to the housing body 31. The cover member 50 is formed to be detachably attachable to the housing body 31. The cover member 50 includes a body portion 51 and engaging portions 52 projecting in the forward direction X1 from the body portion 51. The cover member 50 of this embodiment includes three engaging portions 52 corresponding to the engaging portions 47 of the housing body 31.

The body portion 51 is in the form of a flat plate. The body portion 51 is formed to close an opening in the rearward direction X2 of the housing body 31.

Each engaging portion 52 projects toward the housing body 31 from the body portion 51. Each engaging portion 52 is a resilient piece formed to be resiliently deformable. Each engaging portion 52 is formed into a frame body. Each engaging portion 52 includes engaging hole(s) 53 engageable with the engaging portion(s) 47. The engaging portions 47 and the engaging holes 53 are engaged with each other by snap fitting utilizing the resilient deformation of the engaging portions 52. By the engagement of the engaging portions 47 and the engaging holes 53, a united state of the housing body 31 and the cover member 50 is maintained.

### (Configuration of Slider 60)

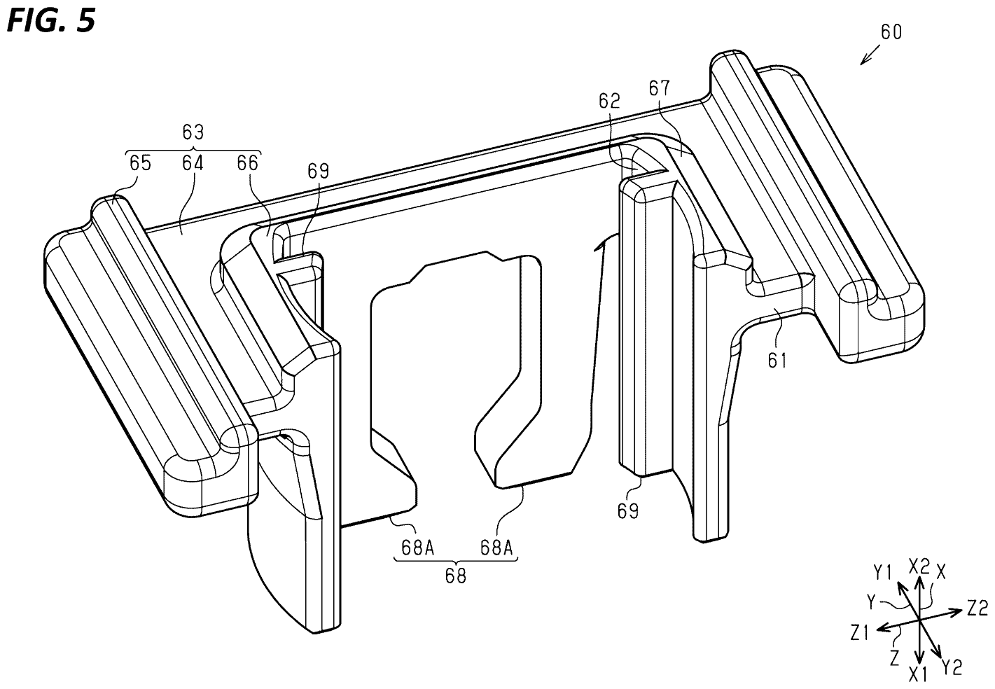

As shown in FIG. 5, the slider 60 includes a body portion 61, a spring accommodating portion 63, the connection guaranteeing portion 68 and the guide protrusions 69. The slider 60 is a single component integrally formed with the body portion 61, the spring accommodating portion 63, the connection guaranteeing portion 68 and the guide protrusions 69. The slider 60 is made of resin.

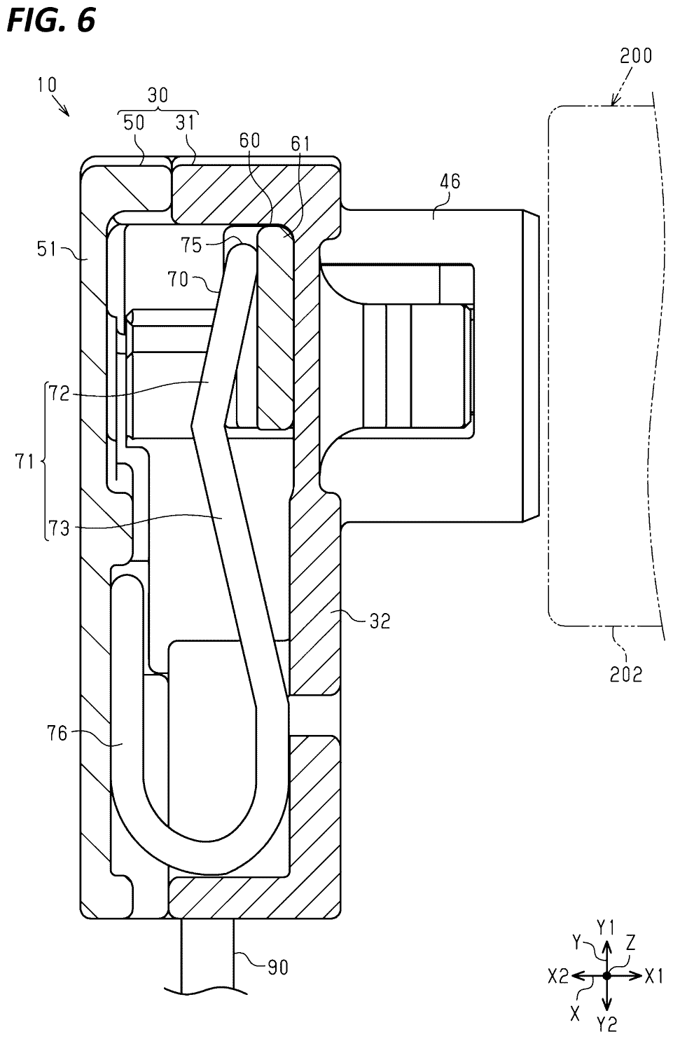

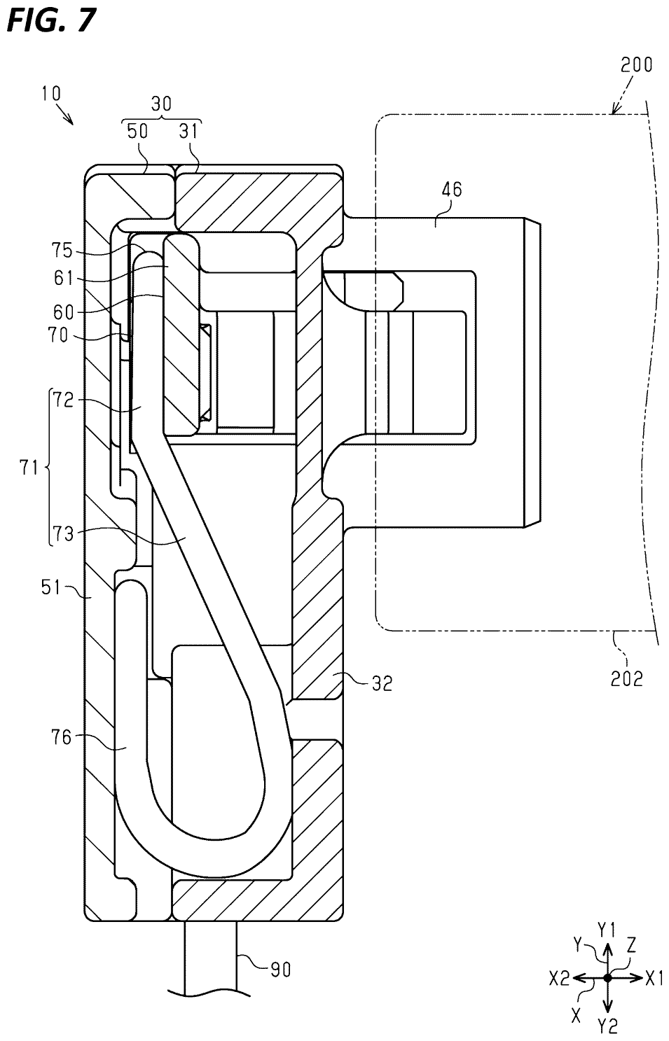

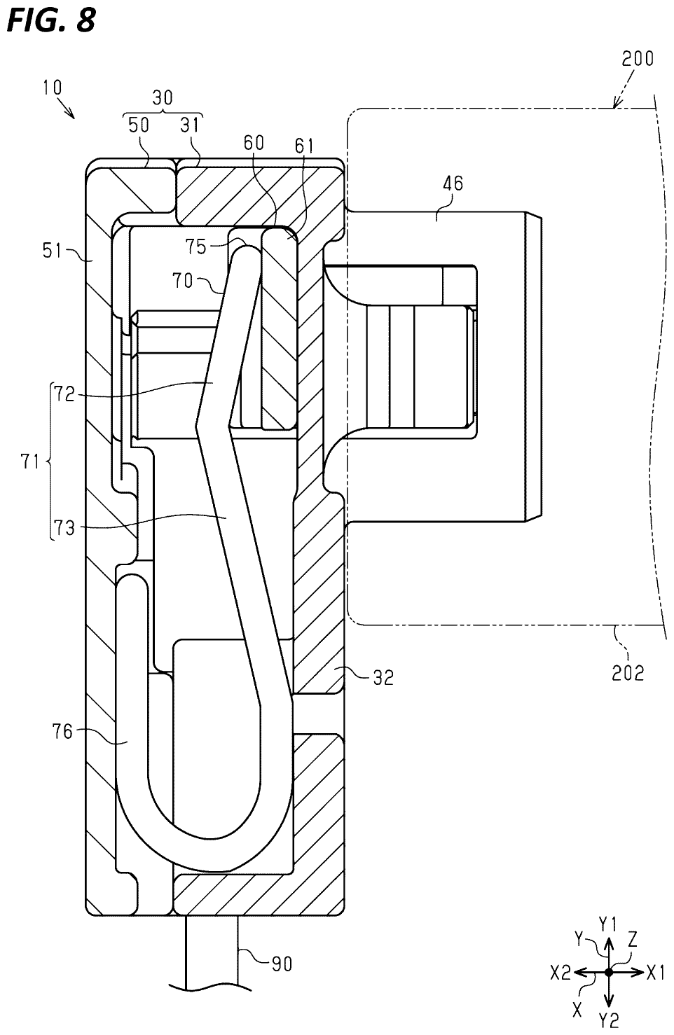

As shown in FIGS. 6 to 12, the slider 60 is accommodated inside the housing 30. The slider 60 is held movably to a first position (see FIGS. 6, 8, 9 and 12) and a second position (see FIGS. 7, 10 and 11) along the first axis X by the housing body 31. As shown in FIGS. 6, 8, 9 and 12, the first position is a position where the body portion 61 is engaged with the base portion 32 of the housing body 31 along the first axis X. As shown in FIGS. 7, 10 and 11, the second position is a position where the slider 60 is pressed in the rearward direction X2 by the mating housing 202. The second position is a position located further in the rearward direction X2 than the first position, specifically a position closer to the cover member 50 than the first position.

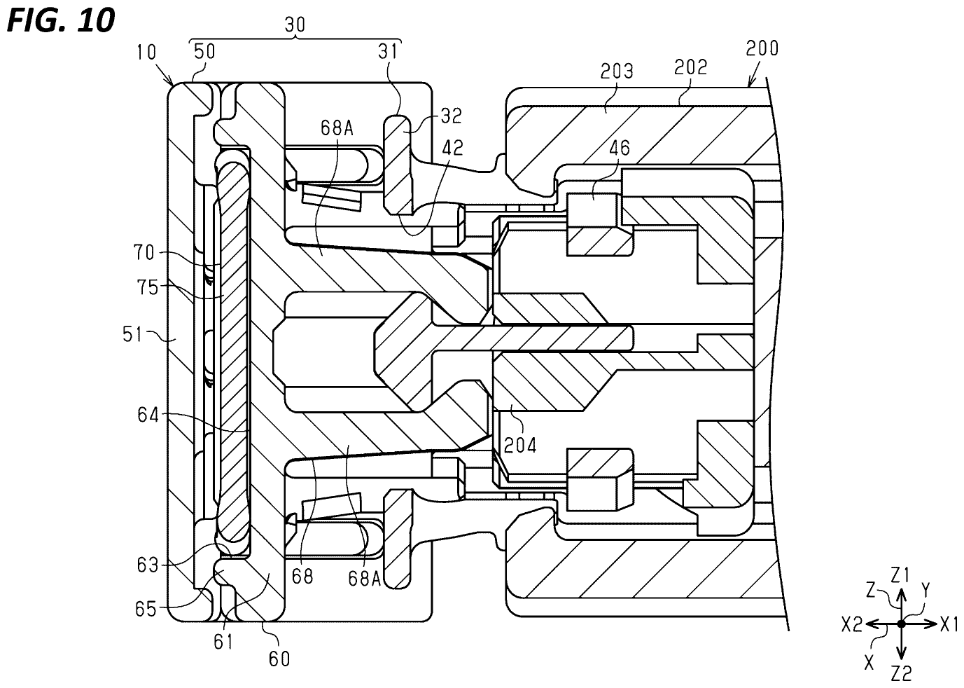

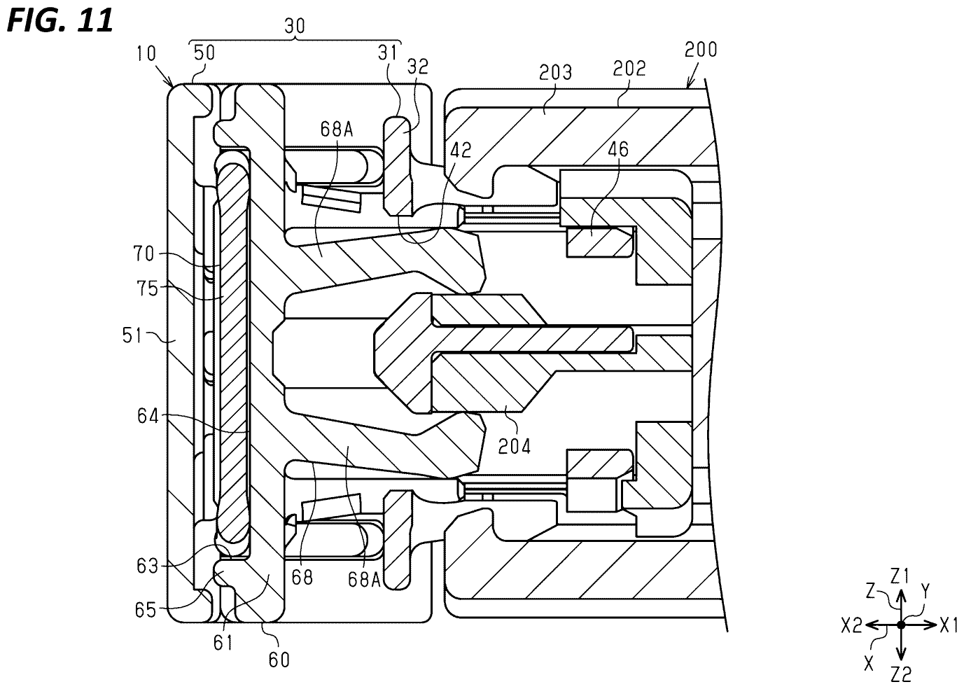

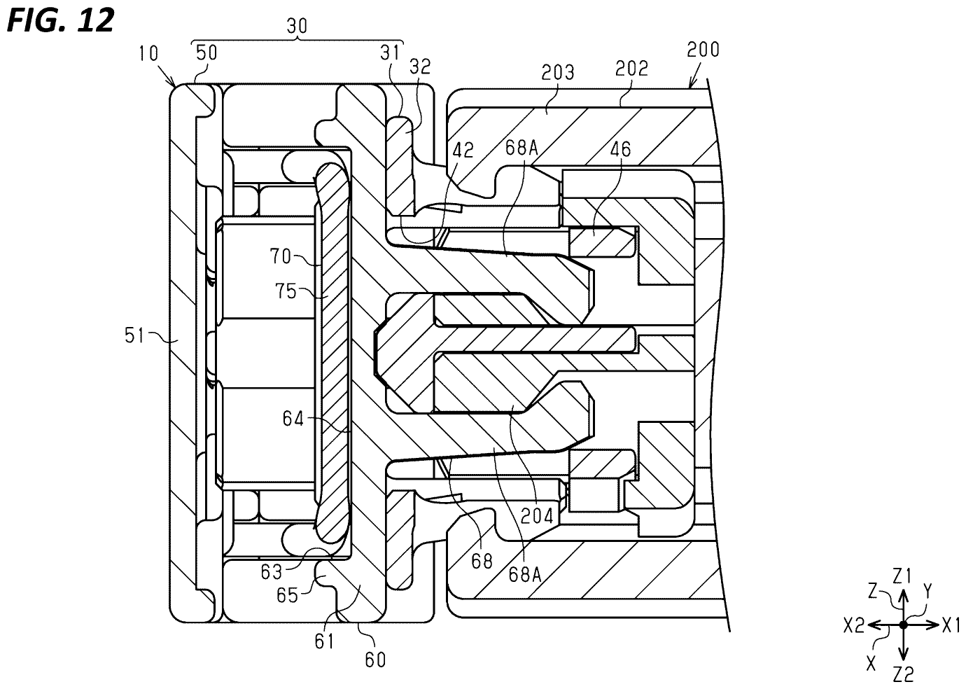

As shown in FIG. 10, when the housing 30 and the mating housing 202 are connected, the connection guaranteeing portion 68 of the slider 60 is pressed in the rearward direction X2 by the mating-side connection guaranteeing portion 204. In this way, the slider 60 moves in parallel from the first position to the second position along the first axis X while compressing the spring 70 along the first axis X against a biasing force of the spring 70. As shown in FIG. 11, if the slider 60 is further pressed by the mating-side connection guaranteeing portion 204 with the slider 60 arranged at the second position, the connection guaranteeing portion 68 is resiliently deformed to widen an opening and the mating-side connection guaranteeing portion 204 enters the inside of the connection guaranteeing portion 68. In this way, the slider 60 is allowed to move in the forward direction X1. If the connector 10 and the mating connector 200 are properly connected, the slider 60 is biased toward the first position by the spring 70 and the slider 60 moves in parallel from the second position to the first position along the first axis X as shown in FIG. 12.

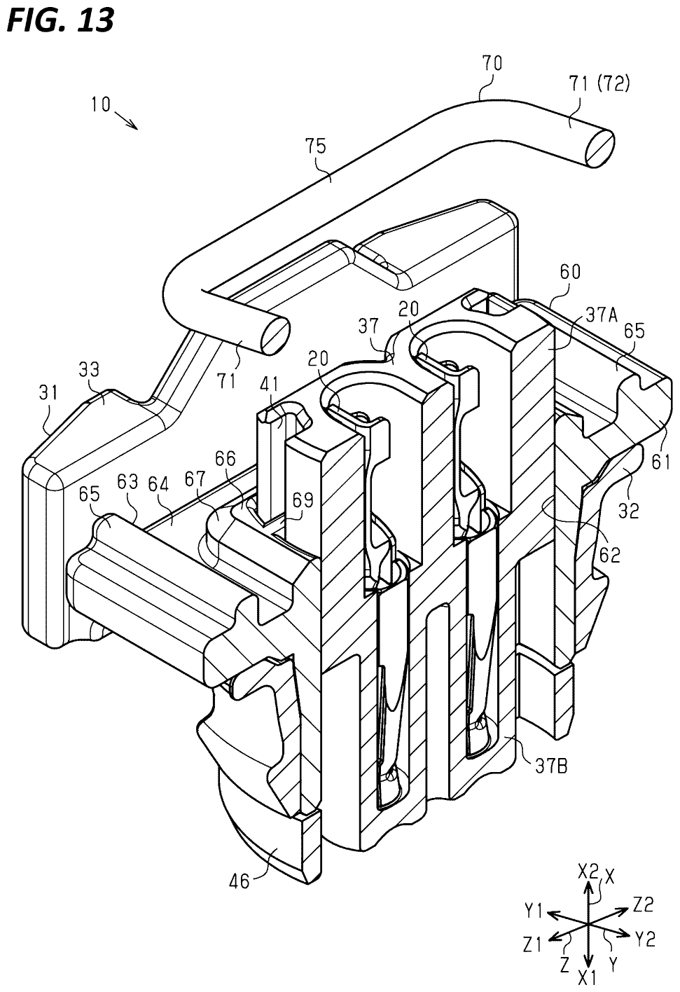

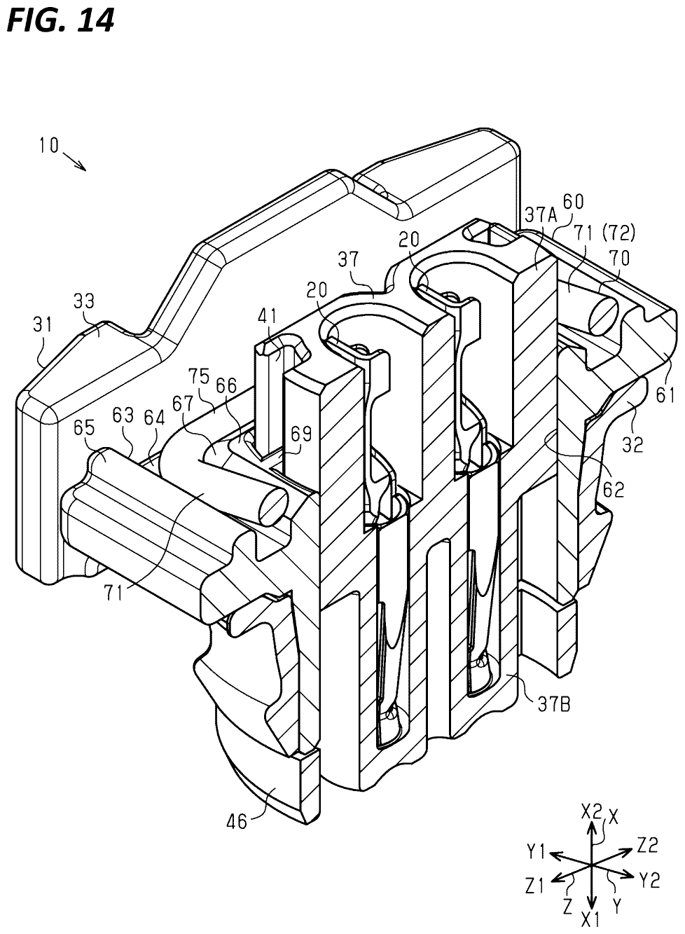

As shown in FIGS. 13 and 14, the body portion 61 of the slider 60 includes a through hole 62 penetrating through the body portion 61 along the first axis X. The terminal accommodating portion 37 of the housing body 31 is inserted into the through hole 62.

The spring accommodating portion 63 is formed to be able to accommodate a part of the spring 70, specifically a pair of the arms 71 of the spring 70 and a coupling portion 75 coupling the pair of arms 71. The spring accommodating portion 63 is formed to have a U shape in a plan view from the forward direction X1. The spring accommodating portion 63 includes a bottom surface 64 and wall portions 65, 66 projecting in the rearward direction X2 from the bottom surface 64. The bottom surface 64 is constituted by an end surface in the rearward direction X2 of the body portion 61. An internal space of the spring accommodating portion 63 is formed by a space surrounded by the bottom surface 64, the wall portions 65, 66 and the peripheral wall 33 of the housing body 31.

The wall portions 65 are provided on an end part in the first width direction Z1 and an end part in the second width direction Z2 of the body portion 61. The wall portion 65 extends straight along the second axis Y. As shown in FIG. 3, the wall portion 65 is accommodated inside the cut portion 43 of the mounting portion 40.

As shown in FIG. 13, the wall portion 66 is provided on a peripheral edge part of the through hole 62. The wall portion 66 is formed over the entire periphery of the through hole 62 along the peripheral edge part of the through hole 62. The wall portion 66 is formed into a U shape in a plan view from the forward direction X1. The wall portion 66 includes, for example, a guiding portion 67. The guiding portion 67 is formed into an inclined surface inclined in the forward direction X1 toward the internal space of the spring accommodating portion 63 from the projecting tip surface (i.e. an end surface in the rearward X2) of the wall portion 66. The guiding portion 67 has a function of guiding the spring 70 into the internal space of the spring accommodating portion 63.

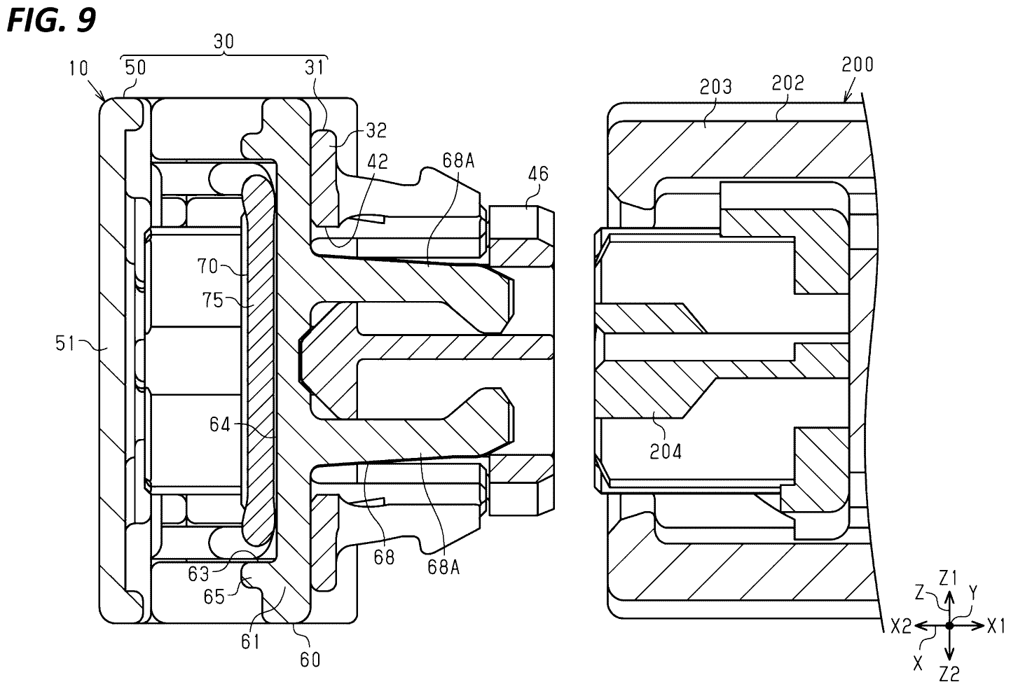

As shown in FIG. 9, the connection guaranteeing portion 68 includes two resilient pieces 68A. The two resilient pieces 68A are provided to face each other along the third axis Z. Each resilient piece 68A extends in the forward direction X1 from the body portion 61. Each resilient piece 68A is in the form of a cantilever with a base end connected to the body portion 61 as a fixed end and a tip on a side opposite to the base end as a free end. Each resilient piece 68A is configured to be deflectable along the third axis Z by being resiliently deformed. Each resilient piece 68A is pressed in the rearward direction X2 by the mating-side connection guaranteeing portion 204 when the housing 30 and the mating housing 202 are connected. The two resilient pieces 68A are configured to be deflected in directions away from each other by being pressed by the mating-side connection guaranteeing portion 204.

As shown in FIG. 5, the slider 60 includes two guide protrusions 69. The two guide protrusions 69 are provided to face each other along the third axis Z. Each guide protrusion 69 extends along the first axis X. Each guide protrusion 69 is provided on the inner peripheral surface of the through hole 62. As shown in FIG. 3, each guide protrusion 69 is formed to be fittable into the guide groove 41 of the housing 31. Each guide protrusion 69 is formed to be engageable with the guide groove 41 in both the upward direction Y1 and the downward direction Y2 in a state fit in the guide groove 41. The slider 60 is movable between the first position and the second position along the first axis X with the respective guide protrusions 69 fit in the guide grooves 41.

### (Configuration of Spring 70)

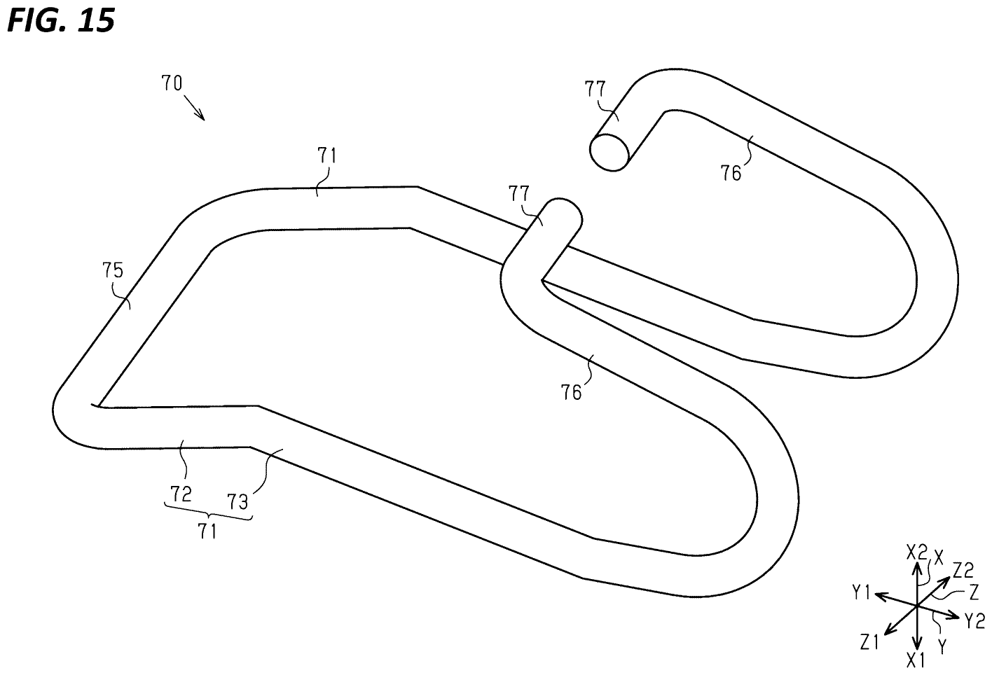

As shown in FIG. 15, the spring 70 is formed of a wire material. The spring 70 is made of metal. The spring 70 includes the pair of arms 71 and the coupling portion 75 coupling the pair of arms 71. The spring 70 includes a pair of folded portions 76 provided on end parts of the pair of arms 71 and a pair of extending portions 77 provided on the tips of the pair of folded portions 76. The spring 70 is a single member in which the arms 71, the coupling portion 75, the folded portions 76 and the extending portions 77 are continuously and integrally formed. The spring 70 of this embodiment does not have a torsion coil shape.

The pair of arms 71 are provided to face each other along the third axis Z. Each arm 71 extends along the second axis Y as a whole. The coupling portion 75 is connected to an end part in the upward direction Y1 of each arm 71. Each arm 71 is, for example, bent into an inverted V shape in a plan view viewed along the third axis Z. Each arm 71 includes a rising portion 72 rising in a first oblique direction from the coupling portion 75 and a falling portion 73 falling in a second oblique direction intersecting the first oblique direction from an end part (specifically, an end part in the downward direction Y2) of the rising portion 72. As shown in FIG. 6, the rising portion 72 is formed to be inclined toward the cover member 50 (here, in the rearward direction X2) with distance from the coupling portion 75. The falling portion 73 is formed to be inclined toward the housing body 31 (here, in the forward direction X1) with distance from the rising portion 72. An end part in the upward direction Y1 of the rising portion 72, i.e. an end part in the upward direction Y of the arm 71, is in contact with the slider 60. An end part in the downward direction Y2 of the falling portion 72, i.e. an end part in the downward direction Y2 of the arm 71 is in contact with the housing body 31. As shown in FIG. 3, the rising portion 72 is accommodated in the spring accommodating portion 63 of the slider 60. The falling portion 73 is accommodated in the spring accommodating portion 45 of the housing body 31.

As shown in FIG. 15, the coupling portion 75 couples the end parts in the upward direction Y1 of the pair of arms 71. The coupling portion 75 continuously extends from the end part in the upward direction Y1 of one arm 71 to the end part in the upward direction Y1 of the other arm 71. The coupling portion 75 extends along the third axis Z. As shown in FIG. 9, the coupling portion 75 is accommodated in a part of the spring accommodating portion 63. Specifically, the coupling portion 75 is accommodated in a part of the spring accommodating portion 63 overlapping the connection guaranteeing portion 68 along the first axis X. The coupling portion 75 is in contact with the bottom surface 64 of the spring accommodating portion 63. The coupling portion 75 is linearly in contact with the bottom surface 64 along the third axis Z. That is, the coupling portion 75 is in line contact with the bottom surface 64.

As shown in FIG. 15, the pair folded portions 76 are provided to face each other along the third axis Z. Each folded portion 76 is formed to be folded toward the end part in the upward direction Y1 of each arm 71 from an end part in the downward direction Y2 of each arm 71. As shown in FIG. 6, each folded portion 76 is formed to be folded in a direction (here, in the rearward direction X2) away from the base portion 32 of the housing body 31. Each folded portion 76 is folded into a U shape from the end part in the downward direction Y2 of each arm 71. Each folded portion 76 is provided to be able to contact the inner surface of the cover member 50, i.e. an end surface in the forward direction X1 of the body portion 51.

As shown in FIG. 15, each extending portion 77 extends from the tip (here, end part in the upward direction Y1) of each folded portion 76 toward the other arm 71. Each extending portion 77 extends along the third axis Z. The pair of extending portions 77 are provided apart from each other. In other words, a gap is provided between the pair of extending portions 77. Each extending portion 77 is provided to be able to contact the inner surface of the cover member 50 (see FIG. 4).

### (Configuration of Ferrite Core 80)

As shown in FIG. 2, the ferrite core 80 is mounted on the outer peripheries of the wires 90. The ferrite core 80 is formed to surround the outer peripheries of the wires 90. The wire 90 is formed to pass through the ferrite core 80 along the second axis Y. The ferrite core 80 is accommodated in the ferrite accommodating portion 38 of the housing body 31.

### (Manufacturing Method of Connector 10)

Next, a manufacturing method of the connector 10 is described.

As shown in FIG. 3, the slider 60 is first mounted into the mounting portion 40 of the housing body 31. In particular, the guide protrusions 69 are fit into the guide grooves 41 and the slider 60 is slid to the first position along the forward direction X1 with the wall portions 65 arranged in the cut portions 43. At this time, the slider 60 is slid along the forward direction X1 with the guide protrusions 69 guided by the guide grooves 41.

Subsequently, the terminals 20, the wires 90 connected to the terminals 20 and the ferrite core 80 mounted on the outer peripheries of the wires 90 are inserted into the terminal accommodating portion 37 and the ferrite accommodating portion 38 of the housing body 31 along the forward direction X1.

Subsequently, the spring 70 is mounted into the housing body 31 and the slider 60. Specifically, the spring 70 is so mounted into that the housing body 31 that the end parts in the downward direction Y2 of the respective arms 71 of the spring 70 are accommodated into the respective spring accommodating portions 45 of the housing body 31. At this time, the coupling portion 75 of the spring 70 may not be accommodated in the spring accommodating portion 63 of the slider 60. For example, the coupling portion 75 may be on the tip surface of the wall portion 66 or the guiding portion 67 (see FIG. 13).

Subsequently, as shown in FIG. 6, the cover member 50 is attached to the housing body 31. The spring 70 is pressed in the forward direction X1 by this cover member 50. In this way, as shown in FIG. 14, the coupling portion 75 of the spring 70 and the rising portions 72 of the respective arms 71 are guided into the spring accommodating portion 63 along the guiding portion 67. As a result, the spring 70 can be suitably accommodated into the spring accommodating portion 63 of the slider 60.

The connector 10 can be manufactured by the above process.

### (Connection Method of Connector 10 and Mating Connector 200)

Next, a connection method of the connector 10 and the mating connector 200 is described.

First, as shown in FIGS. 6 and 9, the connector 10 is prepared and the mating connector 200 are prepared. Then, as shown in FIG. 9, the connector 10 and the mating connector 200 are so arranged that the fitting tube portion 46 and the mating-side fitting tube portion 203 face each other. At this time, the slider 60 is arranged at the first position and the connection guaranteeing portion 68 of the slider 60 and the mating-side connection guaranteeing portion 204 of the mating connector 200 are facing each other.

Subsequently, when the connection of the connector 10 and the mating connector 200 is started as shown in FIG. 10, an end surface in the rearward direction X2 of the mating-side connection guaranteeing portion 204 is brought into contact with an end surface in the forward direction X1 of the connection guaranteeing portion 68. As the connection of the connector 10 and the mating connector 200 proceeds, the connection guaranteeing portion 68 is pressed in the rearward direction X2 by the mating-side connection guaranteeing portion 204. In this way, as shown in FIG. 7, the slider 60 is moved from the first position to the second position along the first axis X while compressing the spring 70 along the first axis X. At this time, as shown in FIG. 14, the slider 60 is slid from the first position to the second position along the first axis X with the guide protrusions 69 fit in the guide grooves 41. In this way, the slider 60 is slid along the first axis X with the guide protrusions 69 engaged with the guide grooves 41 along the second axis Y, wherefore the slider 60 can be suppressed from being inclined with respect to the second axis Y. Further, as shown in FIG. 10, the coupling portion 75 of the spring 70 is provided to overlap the connection guaranteeing portion 68, which is a part to be pressed by the mating-side connection guaranteeing portion 204, on the first axis X. Since this coupling portion 75 is in contact with the slider 60 along the third axis Z, the inclination of the slider 60 with respect to the third axis Z can be suppressed when the slider 60 is slid along the first axis X.

Subsequently, when the connection guaranteeing portion 68 is further pressed in the rearward direction X2 by the mating-side connection guaranteeing portion 204 with the slider 60 arranged at the second position as shown in FIG. 11, the pair of resilient pieces 68A of the connection guaranteeing portion 68 are resiliently deformed away from each other. In this way, the mating-side connection guaranteeing portion 204 is inserted between the pair of resilient pieces 68A. This allows the slider 60 to move in the forward direction X1. Thereafter, when the connector 10 and the mating connector 200 are properly connected, the slider 60 is biased toward the first position by a reaction force of the spring 70 and the slider 60 moves in parallel from the second position to the first position along the first axis X as shown in FIG. 12. At this time, the spring 70 presses the slider 60 in the forward direction X1 by the coupling portion 75 in line contact with the slider 60 along the third axis Z. Thus, when the slider 60 is slid from the second position to the first position along the first axis X, the inclination of the slider 60 with respect to the third axis Z can be suppressed. As just described, when the connector 10 and the mating connector 200 are properly connected, the slider 60 is arranged at the first position with the entire mating-side connection guaranteeing portion 204 accommodated in the connection guaranteeing portion 68. Note that, unless the connector 10 and the mating connector 200 are properly connected, the connector 10 is pushed back in the rearward direction X2 by the reaction force of the spring 70.

Next, functions and effects of this embodiment are described.

(1) The connector 10 is provided with the terminals 20, the housing 30 for holding the terminals 20, the slider 60 to be accommodated inside the housing 30 and provided movably to the first position and the second position along the first axis X and the spring 70 for biasing the slider 60. The spring 70 includes the pair of arms 71 extending along the second axis Y intersecting the first axis X and the coupling portion 75 coupling the pair of arms 71 and configured to contact the slider 60. The coupling portion 75 extends along the third axis Z intersecting both the first and second axes X, Y. The spring 70 biases the slider 60 toward the first position with the coupling portion 75 held in contact with the slider 60 along the third axis Z.

According to this configuration, the slider 60 is biased toward the first position by the spring 70 with the coupling portion 75 coupling the pair of arms 71 held in line contact with the slider 60 along the third axis Z. In this way, a contact region of the spring 70 and the slider 60, particularly a contact region along the third axis Z, can be increased as compared to the case where only the pair of arms 71 contact the slider 60. Thus, when the slider 60 is moved from the second position to the first position along the first axis X by a biasing force of the spring 70, the biasing force can be applied to the slider 60 in a well-balanced manner and the slider 60 can be moved in a well-balanced manner. Therefore, when the slider 60 moves from the second position to the first position, the inclination of the slider 60 with respect to the third axis Z can be suitably suppressed and the slider 60 can be moved in a stable posture. As a result, the reaction force of the spring 70 can be suitably applied to the slider 60, wherefore connection to the mating connector 200 can be suitably guaranteed, utilizing the spring 70 and the slider 60. If such a connection guarantee suitably functions, the connector 10 is pushed back in the rearward direction X2 by the reaction force of the spring 70 if the connector 10 and the mating connector 200 are not properly connected. In this way, the occurrence of a connection failure such as an incompletely connected state of the connector 10 and the mating connector 200 can be suitably suppressed. As a result, the connection reliability of the connector 10 and the mating connector 200 can be improved.

(2) Each of the pair of arms 71 includes a first end part (here, the end part in the upward direction Y1) connected to the coupling portion 75 and a second end part (here, the end part in the downward direction Y2) provided on a side opposite to the first end part. The spring 70 includes the folded portions 76 folded from the second end parts toward the first end parts.

According to this configuration, the spring 70 can be so structured that the second end part of each arm 71 does not have a torsion coil shape. In this way, the spring 70 can be reduced in size as compared to the conventional structure having the torsion coil shape.

(3) Since the spring 70 can be reduced in size, the size of the ferrite core 80 can be increased. In this case, noise removal performance in the connector 10 can be improved.

(4) The spring 70 further includes the extending portions 77 extending along the third axis Z from the folded portions 76. The extending portion 77 can contact the inner surface of the housing 30, specifically the end surface in the forward direction X1 of the body portion 51 of the cover member 50.

According to this configuration, a contact area of the spring 70 and the inner surface of the housing 30 can be increased by as much as the extending portions 77. By the contact of the spring 70 and the inner surface of the housing 30, a movement of the spring 70 inside the housing 30 can be suitably restricted. Thus, the spring 70 can be suitably maintained in a desired posture inside the housing 30.

(5) Each of the pair of arms 71 includes the rising portion 72 rising in the first oblique direction from the coupling portion 75 and the falling portion 73 falling in the second oblique direction intersecting the first oblique direction from the end part of the rising portion 72. The rising portion 72 is inclined in the direction away from the slider 60 with distance from the coupling portion 75.

According to this configuration, each arm 71 of the spring 70 is formed to be bent into the inverted V shape. In this way, a biasing force can be suitably applied to the slider 60 by each arm 71.

(6) The slider 60 includes the connection guaranteeing portion 68 for guaranteeing the connection to the mating connector 200. The connection guaranteeing portion 68 is a part to be pressed by the mating-side connection guaranteeing portion 204 of the mating connector 200. The coupling portion 75 is provided at a position overlapping the connection guaranteeing portion 68 in a plan view viewed along the first axis X.

According to this configuration, when the connector 10 and the mating connector 200 are connected, the connection guaranteeing portion 68 of the slider 60 is pressed by the mating-side connection guaranteeing portion 204. The coupling portion 75 of the spring 70 is provided to overlap this connection guaranteeing portion 68 in the plan view. Thus, when the connection guaranteeing portion 68 is pressed by the mating-side connection guaranteeing portion 204, the coupling portion 75 is brought into line contact with the slider 60 along the third axis Z at that position overlapping the connection guaranteeing portion 68. Therefore, when the connection guaranteeing portion 68 is pressed by the mating-side connection guaranteeing portion 204, the slider 60 can be suitably supported by the coupling portion 75 of the spring 70. As a result, when the slider 60 is moved from the first position to the second position as being pressed by the mating-side connection guaranteeing portion 204, the inclination of the slider 60 with respect to the third axis Z can be suitably suppressed and the slider 60 can be moved in the stable posture.

(7) The housing 30 includes the guide grooves 41 extending along the first axis X. The slider 60 includes the guide protrusions 69 to be fit into the guide grooves 41 and extending along the first axis X. The guide protrusion 69 is formed to be engageable with the guide groove 41 along the second axis Y. The slider 60 is movable along the first axis X with the guide protrusions 69 fit in the guide grooves 41.

According to this configuration, the slider 60 is moved along the first axis X with the guide protrusions 69 fit in the guide grooves 41. At this time, the guide protrusions 69 are engaged with the guide grooves 41 along the second axis Y. Thus, when the slider 60 moves along the first axis X, the inclination of the slider 60 with respect to the second axis Y can be suitably suppressed and the slider 60 can be moved in the stable posture.

(8) The slider 60 includes the spring accommodating portion 63 for accommodating the arms 71 and the coupling portion 75. The spring accommodating portion 63 includes the bottom surface 64 and the wall portions 65, 66 projecting from the bottom surface 63. The wall portion 66 includes the guiding portion 67 for guiding the spring 70 into the internal space of the spring accommodating portion 63.

According to this configuration, when the spring 70 is mounted into the housing 30, the spring 70 is moved along the guiding portion 67, whereby the spring 70 can be smoothly inserted into the internal space of the spring accommodating portion 63. In this way, the assembly workability of the connector 10 can be improved.

(9) Since the spring 70 can be inserted into the internal space of the spring accommodating portion 63 along the guiding portion 67, the spring 70 can be suitably set at a proper position, i.e. in the internal space of the spring accommodating portion 63.

(10) The housing 30 includes the housing body 31 having the terminal accommodating portion 37 for accommodating the terminals 20 and the cover member 50 to be attached to the housing body 31. The housing 30 is formed into the tube surrounding the outer periphery of the slider 60 and the outer peripheries of the terminals 20 by uniting the housing body 31 and the cover member 50.

According to this configuration, the housing 30 is formed into the tube surrounding the outer periphery of the slider 60 and the outer peripheries of the terminals 20 by a plurality of components, i.e. the housing body 31 and the cover member 50. In this way, the housing 30 can be attached to the terminals 20 and the like later since the housing 30 is divided into the plurality of components while having a tubular shape. Therefore, the assembly workability of the terminals 20 and the like with the housing 30 can be improved and the assembly workability of the connector 10 can be improved.

### Modifications

The above embodiment can be modified and carried out as follows. The above embodiment and the following modifications can be carried out in combination without technically contradicting each other.
The structure of the spring 70 in the above embodiment may be changed as appropriate.
The extending portions 77 of the spring 70 may be omitted.
The structure of each arm 71 may be changed. For example, the rising portion 72 and the falling portion 73 may be omitted and each arm 71 may be shaped to extend straight along the second axis Y.
The structure of the slider 60 in the above embodiment may be changed as appropriate.
The guiding portion 67 may be omitted from the wall portion 66 of the spring accommodating portion 63.
The guide protrusions 69 of the slider 60 may be omitted.
The structure of the connection guaranteeing portion 68 may be changed as appropriate.
The structure of the housing 30 in the above embodiment may be changed as appropriate.
The engagement structure of the housing body 31 and the cover member 50 may be changed as appropriate.
Although the housing body 31 and the cover member 50 are constituted by separate components in the housing 30 of the above embodiment, there is no limitation to this. For example, the housing body 31 and the cover member 50 may be integrally formed via a hinge or the like.
Although the housing 30 is composed of two divided bodies, i.e. the housing body 31 and the cover member 50, in the above embodiment, there is no limitation to this. For example, the housing 30 may be composed of three or more divided bodies.
The structure of the housing body 31 may be changed as appropriate. The guide grooves 41 may be omitted. The cut portions 43 may be omitted.
The ferrite core 80 in the above embodiment may be omitted.
The structure of the terminal 20 in the above embodiment may be changed as appropriate. The terminal 20 may be changed to have such a structure that the wire connecting portion 21 and the female terminal portion 22 are arranged on a straight line.
The embodiment disclosed this time should be considered illustrative in all aspects, rather than restrictive. The scope of the present invention is represented not by the above meaning, but by claims and is intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal;
a housing for holding the terminal;
a slider to be accommodated inside the housing, the slider being movable to a first position and a second position along a first axis; and
a spring for biasing the slider,
the spring including a pair of arms extending along a second axis intersecting the first axis and a coupling portion coupling the pair of arms, the coupling portion contacting the slider,
the coupling portion extending along a third axis intersecting both the first axis and the second axis, and
the spring biasing the slider toward the first position with the coupling portion held in contact with the slider along the third axis.

2. The connector of claim 1, wherein:
each of the pair of arms includes a first end part connected to the coupling portion and a second end part provided on a side opposite to the first end part, and
the spring further includes folded portions folded from the second end parts toward the first end parts.

3. The connector of claim 2, wherein:
the spring further includes extending portions extending along the third axis from the folded portions, and
the extending portion is capable of contacting an inner surface of the housing.

4. The connector of claim 1, wherein:
each of the pair of arms includes a rising portion rising in a first oblique direction from the coupling portion and a falling portion falling in a second oblique direction intersecting the first oblique direction from an end part of the rising portion, and
the rising portion is inclined in a direction away from the slider with distance from the coupling portion.

5. The connector of claim 1, wherein:
the slider includes a connection guaranteeing portion for guaranteeing connection to a mating connector,
the connection guaranteeing portion is a part to be pressed by a mating-side connection guaranteeing portion of the mating connector, and
the coupling portion is provided at a position overlapping the connection guaranteeing portion in a plan view viewed along the first axis.

6. The connector of claim 1, wherein:
the housing includes a guide groove extending along the first axis,
the slider includes a guide protrusion to be fit into the guide groove, the guide protrusion extending along the first axis,
the guide protrusion is formed to be engageable with the guide groove along the second axis, and
the slider is movable along the first axis with the guide protrusion fit in the guide groove.

7. The connector of claim 1, wherein:
the slider includes a spring accommodating portion for accommodating the arms and the coupling portion,
the spring accommodating portion includes a bottom surface and a wall portion projecting from the bottom surface, and
the wall portion includes a guiding portion for guiding the spring into an internal space of the spring accommodating portion.

8. The connector of claim 1, wherein:
the housing includes a housing body having a terminal accommodating portion for accommodating the terminal and a cover member to be attached to the housing body, and
the housing is formed into a tube surrounding an outer periphery of the slider and an outer periphery of the terminal by uniting the housing body and the cover member.
